(19) United States
(12) Patent Application Publication
(10) Pub. No.: US 2012/0127994 A1
(43) Pub. Date: May 24, 2012

(54) MULTICAST COMMUNICATION METHOD, APPARATUS AND SYSTEM FOR INTERMITTENTLY CONNECTED NETWORK

(75) Inventors: Seok-Kap KO, Gwangju-si (KR); Seung-Hun OH, Gwangju-si (KR); Byung-Tak LEE, Suwon-si (KR); Jai-Sang KOH, Gwangju-si (KR)

(73) Assignee: Electronics and Telecommunications Research Institute, Daejeon-si (KR)

(21) Appl. No.: 13/296,475

(22) Filed: Nov. 15, 2011

(30) Foreign Application Priority Data
Nov. 22, 2010 (KR) 10-2010-0116284

(51) Int. Cl. H04L 12/56

(52) U.S. Cl. 370/390

(57) ABSTRACT

A multicast communication method, a multicast communication apparatus and a multicast communication system in a network environment lacking a continuous connectivity. The source node device selects a group leader device which is able to forward data to group member devices belonging to a multicast group, and forwards the data to the selected group leader device, thereby reducing traffic between node devices, improving network reliability and saving the communication cost.

### CROSS-REFERENCE TO RELATED APPLICATION

This application claims the benefit under 35 U.S.C. §119(a) of Korean Patent Application No. 10-2010-0116284, filed on Nov. 22, 2010, the disclosure of which is incorporated by reference in its entirety for all purposes.

### BACKGROUND

1. Field

The following description relates to a multicast communication technology, and more particularly, to a multicast communication technology for an intermittently connected network.

2. Description of the Related Art

According to a multicast method in an IP network environment, a multicast address used to identify a group is determined in advance. A node device may join a desired multicast group in an IP network environment through a group management protocol. A multicast sender transfers packets to a destination based on the multicast address. In a mobile ad-hoc network environment, packets are transferred to node devices belonging to a group through a multicast distribution tree or mesh that is formed between the node devices.

A network between node devices may be an intermittently connected network, which is referred to as a delay tolerant network (DTN) or a disruption tolerant network. The DTN lacks a continuous connectivity between node devices, causing a difficulty in forming a multicast distribution tree.

A method for delivering packets to a local area in a mobile ad-hock network environment has been suggested. An example of the delivering method is Geocast in which a source node delivers a packet to a nearby node if the nearby node is disposed nearer to a destination area than the source node is.

There are several shortcomings associated with applying the Geocast scheme to a DTN. First, the Geocast scheme performs a data routing based on the current position of nearby node devices. However, if a current nearby node device, which has been near to a destination area, moves to another area in the DTN, messages may be transferred unwanted areas other than the destination area.

In addition, the Geocast scheme requires a high density of node devices and does not consider the movement path of the node device. However, the DTN may have a low density of node devices and fail to make a connection in a multicast region. In addition, the DTN needs to consider the movement path of the node device to enhance the success rate of forwarding. In addition, Geocast based multicasting does not service a node device arriving late, which also needs to be considered in the DTN.

Further, the Geocast scheme does not check if messages have been properly delivered to a destination area. However, it needs to checked whether the delivery to the destination has been properly achieved in the case of DTN. In addition, when a forwarding region is expanded to increase the success rate of forwarding in the Geocasting scheme, unnecessary traffic is also increased and thus the performance of forwarding is degraded. In particular, the further a source node device is distant from the multicast region, the higher loss of forwarding is.

### SUMMARY

In one aspect, there is provided a multicast technology capable of effectively supporting a multicast service in an intermittently connected network.

In one general aspect, there is provided a multicast communication method by a source node device which supports a multicast in a network lacking a continuous connectivity between node devices. The multicast communication method is as follows. A group leader device, which is able to forward data to group member devices belonging to a multicast group, is selected. The data is forwarded to the selected group leader device. The network lacking a continuous connectivity may be a Delay tolerant network.

In the selecting of the group leader device, the source node device selects the group leader device in consideration of at least one of locality, the number of links and the number of nodes in a multicast region that is specified by the source node device. Alternatively, the selecting of the group leader device includes selecting a multicast path passing through the multicast region as a group leader path, and selecting a node device, which moves along the selected group leader path, as the group leader device. The selecting of the group leader device includes if the group leader device is selected according to a criteria for multicast reception, receiving a result of the selecting from a server or a distributed network; and finally selecting the group leader device according to the received result of the selecting.

In the forwarding of the data to the selected group leader device, the data is forwarded to the selected group leader device through a path that is determined in a unicast routing scheme.

The multicast communication method includes receiving an acknowledgement message from the group leader device having received the data; and stopping forwarding data to the group leader device if the received acknowledgement message is normal. In the receiving of the acknowledgement message from the group leader device having received the data, the acknowledgement message is received from the group leader device through at least one of the network lacking a continuous connectivity and an additional communication network other than the network lacking a continuous connectivity.

In another general aspect, there is provided a multicast communication method by a source node device which supports a multicast in a network lacking a continuous connectivity between node devices. The multicast communication method is as follows. Data is forwarded to the node devices and acknowledgement messages are received from the node devices in response to the forwarded data. A group leader device is selected based on the received acknowledge messages among the node devices having transferred the acknowledgement message, the group leader device capable of forwarding data to group member devices belonging to a multicast group.

In another general aspect, there is provided a multicast communication method by a group leader device which supports a multicast in a network lacking a continuous connectivity between node devices. The multicast communication method is as follows. A source node device selects the group leader device. A data is transferred from the source node device to group member devices belonging to a multicast group after the selecting of the group leader device by the source node device.

In another general aspect, there is provided a source node device which supports a multicast in a network lacking a continuous connectivity between node devices. The source node device includes a group leader selecting unit and a communication unit. The group leader selecting unit is configured to select a group leader device capable of forwarding a data to group member devices belonging to a multicast group. The communication unit is configured to forward the data to the selected group leader device.

In another general aspect, there is provided a multicast communication system in a network environment lacking a continuous connectivity between node devices. The multicast communication system includes a source node device and the group leader device. The source node device is configured to select a group leader device and forward a data to the selected group leader device. The group leader device is configured to forward the data, which has been transferred from the source node device, to group member devices belonging to a multicast group.

As described above, the source node device selects a multicast group leader device to perform a DTN multicast service, thereby preventing the traffic from being overlapped and widely spreading between a source node device and a multicast group. That is, a data is not transferred to a path which does not lead to a destination, thereby reducing the traffic. In addition, data transfer is blocked for a path other than a multicast path, which is made through a group leader device, so that unnecessary data transfer is prevented.

In addition, the source node device does not need to receive an acknowledge message from all members of a group. Accordingly, the multicast service is supported in a rapid and reliable manner and the time and cost required for communication in a multicast service is reduced. In order to ensure a reliable multicast forwarding, an acknowledgement needs to be received when a message arrives at a destination node. According to this example, the source node device receives an acknowledgement message only from a group leader device, thereby saving the time and cost and preventing too much traffic.

With the selecting of a group leader device, an additional communication channel is not required, so that the cost for communication is reduced. That is, there is no need for an additional communication, such as a high priced mobile communication network required for receiving an acknowledgement message, so that the cost for communication is reduced.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 shows an example of a multicast communication system for a network environment lacking a continuous connectivity between node devices.

FIG. 2 shows an example of a multicast communication method for a network environment lacking a continuous connectivity between node devices.

FIG. 3 shows an example of a multicast communication process in which a source node device selects a fixed node device as a group leader device to perform a multicast communication.

FIGS. 4A to 4C show an example of a criteria for selecting a group leader device.

FIG. 5 shows an example of a multicast communication process in which a source node device receives an acknowledgement message.

FIG. 6 shows a multicast communication process in the case where a fixed node device does not exist in a multicast region.

FIG. 7 shows an example of a multicast communication method in which a source node device transfers data without selecting a group leader device.

FIG. 8 shows an example of a multicast communication method using a bus line map.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

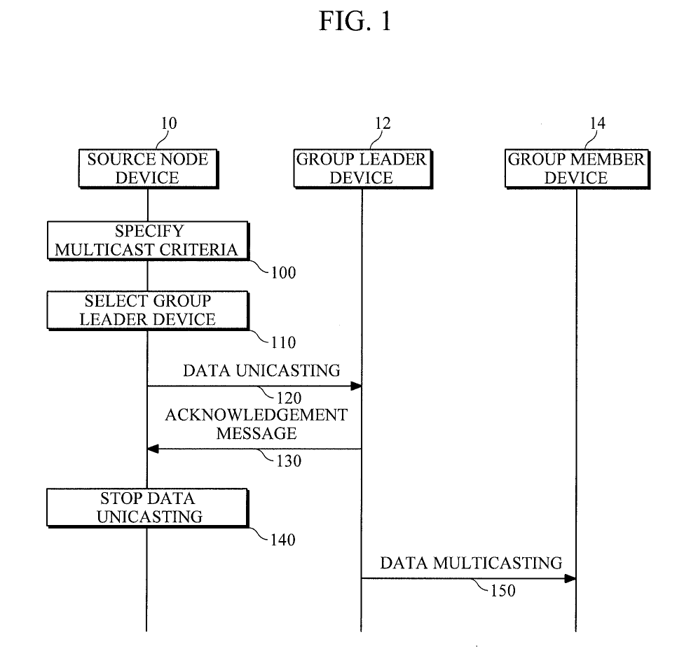

FIG. 1 shows an example of a multicast communication system for a network environment lacking a continuous connectivity between node devices

As shown in FIG. 1, a multicast communication system 1 includes a source node device 10, a group leader device 12 and a group member device 14. The source node device 10 includes an environment setting unit 1000, a group leader selecting unit 1010 and a communication unit 1020. The source node device 10 may include a plurality of group member devices 14.

The network lacking a continuous connectivity between node devices may be a delay tolerant network or a disruption tolerant network that is referred to as DTN. The DTN transfers a data in a store-carry-forward scheme by use of a mobile node device lacking a direct connectivity with other node devices. That is, the DTN stores a message and carries the stored message to forward the message to another node device.

The DTN uses a predetermined multicast concept which is different from a general multicast concept in which node devices are registered in a multicast group. According to the predetermined multicast concept, multicast addresses are not clearly specified but a conditional expression for receiving node devices to receive data is specified. This concept is mentioned at “Intentional Naming in DTN”, http://tools.ietf.org/html/draft-pbasu-dtnrg-naming-00, stated in Delay-Tolerant Networking Research Group (DTNRG) of International Engineering Task Force (IETF).

Through the Intentional Naming, an administrative district or an actual address may be specified for destinations. Alternatively, a multicast region may be specified based on coordinates in the form of the latitude-longitude-radius at destinations. According to this multicast concept, the set of receiving nodes is changed depending on a criteria that is determined by a sending node, so that a multicast forward tree is not configured in advance.

The present invention provides a technology capable of effectively forwarding data to a multicast group satisfying a predetermined criteria in performing the data multicast service in a DTN through the Intentional Naming. To this end, the source node device 10 selects a group leader device 12 in a multicast group, and forwards data to the selected group leader device 12 through a unicast communication. The source node device 10 is disposed outside of the multicast group while being distant away from the multicast group. The group leader device 12 selected by the source node device 10 forwards data, which has been sent from the source node device 10, to the group member device 14 in the multicast group through a multicast communication.

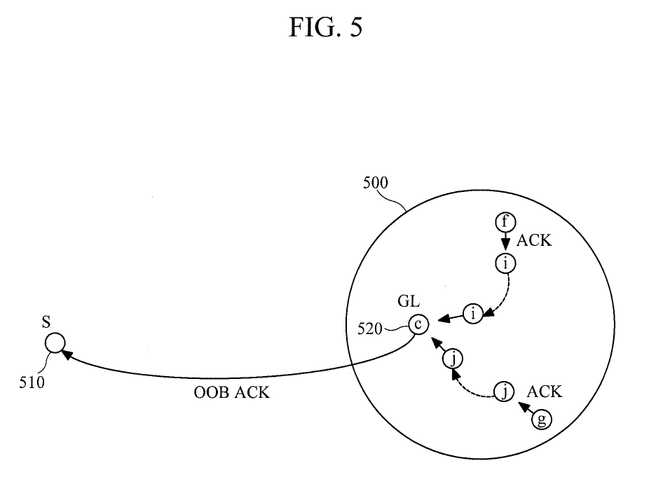

In detail, the environment setting unit 1000 of the source node device 10 specifies a criteria for multicast for node devices, which correspond to a final destination of multicast, in data. The criteria includes regional details, the type of node devices and the effective time for multicast. Details of specifying the multicast criteria will be described later with reference to FIG. 5.

The group leader selecting unit 1010 selects the group lead device 12 capable of transferring data to the group member device 14 in the multicast group.

According to an example, the group leader selecting unit 1010 may be selected according to a criteria for multicast reception in advance. The result of selecting the group leader device may be stored in a server or stored in a DTN in a distributed manner. Then, the communication unit 1020 receives the result of the selecting from the server or the distributed DTN. The group leader selecting unit 1010 selects the group leader device 12 according to the received result of the selecting.

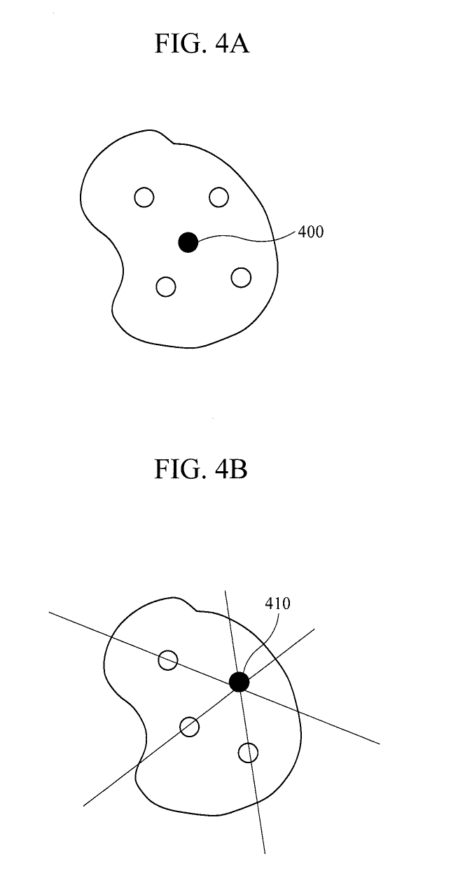

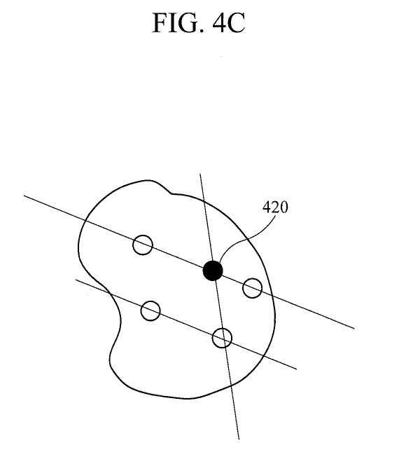

According to another example, the group leader selecting unit 1010 selects the group leading device 12 in consideration of at least one of locality, the number of links and the number of nodes in a multicast region that is specified by the source node device 10. The group leader device 12 may be a fixed node device. Details of the selecting of a group leader device will be described later with reference to FIGS. 4A to 4C.

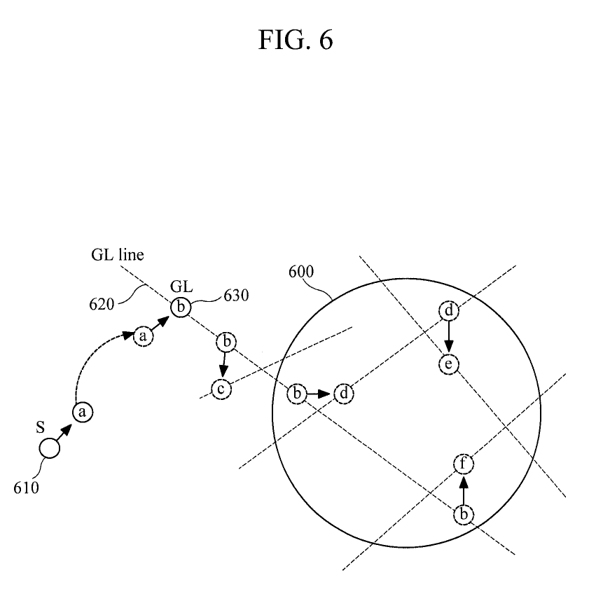

According to another example, the group leader selecting unit 1010 selects a multicast path passing through the multicast region as a group leader path, and selects a node device, which moves along the selected group leader path, as the group leader device 12. This example corresponds to a case in which a fixed node device does not exist in the multicast region, and the details thereof will be described later with reference to FIG. 6.

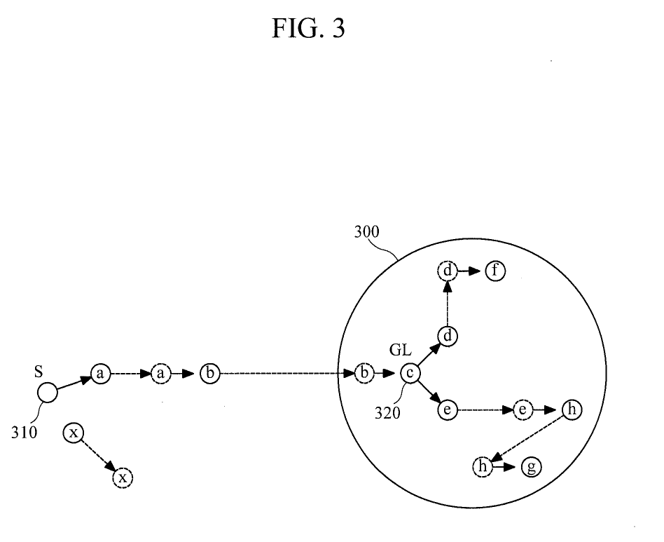

The communication unit 1020 forwards data to the group leader device 12, which is selected by the group leader selecting unit 1010. The communication unit 1020 may forward the data to the selected group leader device 12 through a unicast routing scheme. Details of the unicast routing scheme will described later with reference to FIG. 3. For example, the communication unit 1020 may forward data to the group leader device 120 via mobile node devices that move along a fixed path.

The communication unit 1020 receives an acknowledgement message from the group leader device 11 that has received data. In addition, the communication unit 1020 stops forwarding data to the group leader device 11 if the received acknowledgement message is normal. The communication unit 1020 may receive the acknowledgement message from the group leader device through at least one of the DTN and an additional communication network other than the DTN. The additional communication network may be a 2 generation (2G) or 3 generation (3G) mobile communication network.

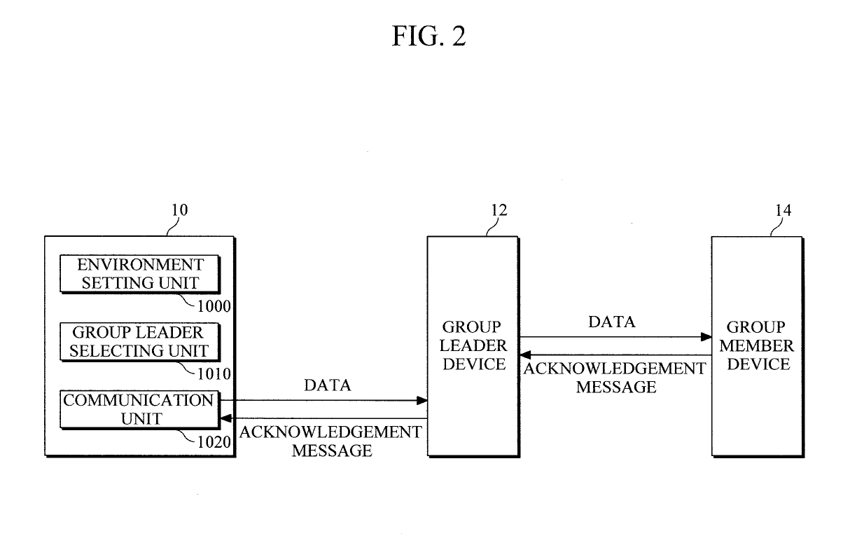

FIG. 2 shows an example of a multicast communication method for a network environment lacking a continuous connectivity between node devices.

As shown in FIG. 2, the source node device 10 specifies a criteria for multicast for node devices, which correspond to the multicast final destination, in a data to be transferred to the final destination (100). The multicast criteria includes regional details, the type of node devices and the effective time for multicast.

The source node device 10 selects the group leader device 12 (110). The group leader device 12 represents a node device capable of forwarding data, which has been transferred from the source node device 10, to group member devices 14 in a multicast group that is set by the source node device 10. The process of selecting the group leader device 12 has been described above with reference to FIG. 1, and the description thereof will be omitted in order to avoid redundancy. The source node device 10 forwards the data to the selected group leader device 12 (120). The data transmission may be achieved through the unicast routing scheme.

The group leader device 12 sends an acknowledgement message to the source node device 10 in response to the data having been transferred from the source node device 10 (130). The group leader device 12 may send the acknowledgement message to the source node device 10 through an additional communication channel other than the DTN. The source node device 10 having received the acknowledgement message stops forwarding data to the group leader device 12 (140). In this manner, the stopping of data forwarding prevents unnecessary traffic between the source node device 10 and the group leader device 12.

Thereafter, the group leader device 12 forwards the data, which has been transferred from the source node device 10, to the group member device 14 in the multicast group (150). According to an example, the group leader device 12 sets a forwarding region by expanding a multicast region that is specified by the source node device 10 and forwards the data to the group member device 14 in the forwarding region. The group leader device 12 forwards the data when the group leader device 12 has a connectivity with the group member device 14 in the forwarding region.

The group leader device 12 receives the acknowledgement message from the group member device 14 in the multicast group which has received the data within the multicast region.

The source node device 10 forwards a data to a node device which newly joins the multicast group within an effective time for multicast that is specified by the source node device 10.

The source node device 10 stops forwarding data to the group leader device 12 if a criteria for multicast forwarding success, which is set by the source node device 10 or the group leader device 12, is satisfied.

Hereinafter, various examples using the configuration and process shown in FIGS. 1 and 2 will be described in detail.

FIG. 3 shows an example of a multicast communication process in which a source node device selects a fixed node device as a group leader device to perform a multicast communication.

As shown in FIG. 3, a dotted line denotes the movement of a node device, and a solid line denotes data communication of a node device. A source node device S 310 sets a multicast region 300 of a destination to which data is to be forwarded. The multicast region 300 may be represented by use of an administrative district, coordinates of the center, the radius or coordinates of the connecting points of polygons. In FIG. 3, a fixed node device existing in a predetermined range corresponding to the coordinates of a center and the radius is assumed as a destination.

Thereafter, the source node device S 310 selects a group leader device GL 320. A method of selecting the group leader device GL 320 may vary depending on the amount of information about the multicast region 300 retained in the source node device S 310.

The source node device S 310 selects the group leader device GL 320 in consideration of the locality, the number of links and the number of nodes existing in the multicast region that is specified by the source node device S 310. In FIG. 3, a fixed node c is selected as the group leader device GL 320. Another example of the selecting of the group leader device GL 320 in consideration of the locality, the number of links and the number of nodes will be described later with reference to FIGS. 4A to 4C.

When the source node device S 310 is connected to other node devices, it is determined whether the source node device S 310 is able to forward data to the group leader device GL 320 via the connected node device.

According to an example, the determining is achieved through a DTN unicast routing scheme. To this end, it is assumed that each of the node devices comes to know the possibility of making a contact with another node device through statistics and analysis. A routing matrix is generated based on the possibility of making a contact. The source node device S 310 calculates the routing cost required to forward data to the final destination according to the generated routing matrix, and selects a path having the minimum routing cost. In this case, at least one subsidiary path may be selected to ensure reliable forwarding.

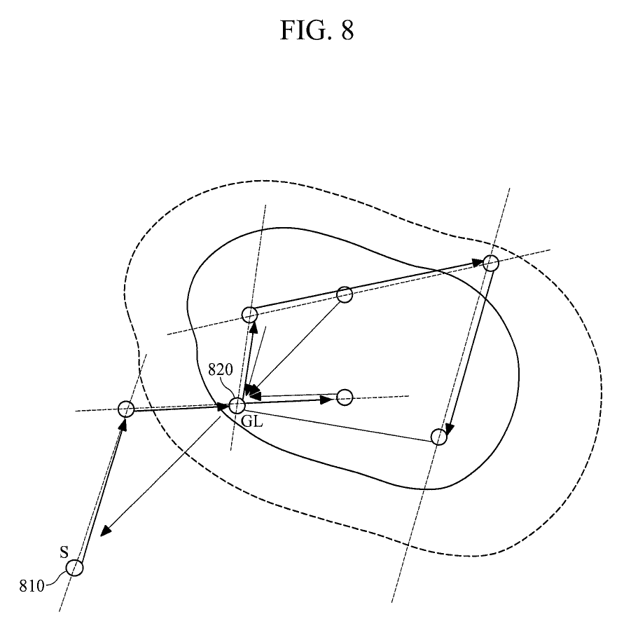

According to another example, it is assumed that mobile node devices move along a fixed path, such as a bus, and there are fixed nodes such as a bus station node. In this case, a map in the form of a bus route map is used for routing. Details thereof will be described later with reference to FIG. 8.

Meanwhile, if the source node device S 310 encounters a node device a, the source node device S 310 forwards a multicast data to the node device a. The next destination is set to the group leader device GL 320. If the source node device S 310 encounters a node device x, it is expected that the chance that data reaches the group leader device GL 320 is very little or the delay time is very significant. Accordingly, the source node device S 310 does not forward data to the node device x.

The node device a having received data from the source node device S 310 encounters a node device b while on the move. The node device a knows the fact that the node device a is able to forward data to a node device c via the node device b. Accordingly, the node device a forwards data to the node device b. The node device b having received the data forwards the data upon encountering the group leader device GL 320 while on the move.

Upon reception of data from the source node device S 310, the node device c corresponding to the group leader device GL 320 sends an acknowledgement message (OOB ACK) confirming a successful reception of the data to the source node device S 310. A method of sending the acknowledgement message by the group leader device GL 320 may vary depending on a network environment and the importance of the acknowledgement message.

According to an example, the group leader device GL 320 may send the acknowledgement message to the source node device S 310 by use of the DTN, which has been used to forward the data to the group leader device GL 320. This example keeps using the DTN, which is assisted by the mobility of the node device, in sending the acknowledgement message. The group leader device 12 sets the source node device S 310 as a destination, and sends the acknowledgement message to the source node device S 310. A routing of an acknowledgement message is achieved through a DTN unicast routing scheme.

The source node device S 310 may keeps forwarding redundant data to other node devices in case of data loss. If the source node device S 310 receives an acknowledgement message from the group leader device GL 320, the source node device S 310 stops forwarding the redundant data. Even though the group leader device GL 320 has sent an acknowledgement message, the redundant data may be continuously transmitted to the group leader device GL 320. In this case, the group leader device GL 320 determines that a loss of acknowledgement messages has occurred, and sends redundant acknowledgement message to the source node device 10.

According to another example, the group leader device GL 320 may send the acknowledgement message to the source node device S 310 by use of an additional communication network other than the DTN. The additional communication network may be a mobile communication network having a wider frequency range of communication. The mobile communication network is relatively costly but reliable. The source node device 10 having received the acknowledgement message through the additional communication network stops forwarding the redundant data.

According to another example, the group leader device GL 320 may send the acknowledgement message to the source node device S 320 through a mixed scheme using the DTN and the additional communication network. For example, in the beginning, the group leader device GL 320 sends the acknowledgement message through the DTN. However, the redundant message is continuously received from the source node device S, the group leader device GL 320 sends the acknowledgement message through the additional communication network.

Meanwhile, after the node device c corresponding to the group leader device GL 320 sends the acknowledgement message to the source node device S 310, the node device c sets a forwarding region having a size equal to or larger than the multicast region 300. Thereafter, the node device c specifies the forwarding region in a data to be forwarded, and starts data propagation. The setting of forwarding region to be larger than the multicast region 300 enables the connectivity to all node devices existing in the multicast region 300. The group leader device GL 320 allows the data, which is to be forwarded, to include details of the group leader GL 320 such that group member devices in a group of the multicast region 300 send acknowledgement messages to the group leader device GL 320.

If a contact is made among the node devices existing in the forwarding region, the multicast data is exchanged among one another. That is, when a contact is made between the node device c corresponding to the group leader device GL 320 and a node device d corresponding to a group member device such that communication is available, the node device c forwards a data to the node device d. In addition, when a contact is made between the node device c corresponding to the group leader device GL 320 and a node device e corresponding to a group member device, the node device c forwards a data to the node device e. If the node device d makes a contact with a fixed node device f while on the move in the multicast region 300, the node device d forwards data to the fixed node device f. Similarly, if the node device e makes a contact with a fixed node device h while on the move, the node device e forwards data to the fixed node device h. When a node device encounters another node device, if the two node devices have the same data, data forwarding is not performed.

Group member devices, which have received a message in the multicast region 300, send acknowledgement messages to the group leader device GL 320. The group member devices may send acknowledgment messages through one of the above described methods of sending an acknowledgement message to the source node device S 310 by the group leader device GL 320. The group member devices are disposed nearer to the group leader device GL 320 than the source node device S 310, and have a higher chance to encounter the group leader device GL 320. Accordingly, the method of sending the acknowledgement message through DTN has a higher rate of success. If the DTN is used, an addition communication network is less used, so that the communication cost is reduced.

FIGS. 4A to 4C show an example of a criteria for selecting a group leader device.

As shown in FIG. 4A, the source node device may select a node device disposed in the center of a multicast region as a group leader device. For example, when a multicast region is assumed to have a circular shape or a polygonal shape, the center point of the multicast region is obtained. The source node device selects a node device 400, which is disposed at the nearest to the center point, as the group leader device on the ground that the distance from the center point to other node devices is the minimum and the connectivity of the center point to other node devices is the highest.

As shown in FIG. 4B, the source node device may select a node device having the largest number of links as the group leader device. For example, if a fixed node device and a mobile node device exist in a multicast region, the source node device selects a node device 410, which has the highest chance to make a contact with other node devices, as the group leader device. The chance to make a contact with other node devices is obtained through statistics. In addition, if a mobile node device moves along a designated line, such as a bus, the source node device selects a node device, which exists in a region where a number of lines overlap one another, as the group leader device.

As shown in FIG. 4C, the source node device 10 selects a source node device on a link having the largest number of node devices as the group leader device. For example, the source node device selects a fixed node device 420 on a line in a multicast region, the line having the largest number of fixed node devices, as the group leader device. The line having the largest number of fixed node devices serve as a backbone, so that data transfer is effectively performed.

FIG. 5 shows an example of a multicast communication process in which a source node device receives an acknowledgement message.

As shown in FIG. 5, a source node device S 510 and a group leader device GL 520 may exchange acknowledgement messages through an addition communication network other than the DTN. However, only the fixed node devices existing in a multicast region 500 forward acknowledgement message by use of the DTN. In the multicast region 500, acknowledgement messages are transferred from the group member devices to the group leader device GL 520 through a DTN unicast routing scheme. For example, in the multicast region 500, a fixed node device f and a fixed node device g encounter a mobile node device i and a mobile node device j, respectively, and forward a respective acknowledgement message to the group leader device GL 520.

According to an example, the source node device S 510 may set the rate of forwarding for a multicast group. For example, if a multicast data is forwarded to two or more fixing node devices, the data transmission may be stopped by the setting. The group leader device GL 520 calculates the number of acknowledgement messages in the group and determines whether the number of acknowledgement messages reaches the rate of forwarding. If the rate of forwarding has been reached, the multicast data transfer stops. The source node device S 510 may request a notification indicating whether the rate of forwarding has been reached. In this case, the group leader device GL 520 sends the source node device S 510 a message indicating that the rate of forwarding has been reached.

According to another example, the source node device S 510 may set the effective time for multicast. The group leader device GL 520 and the group member devices existing in the forwarding region do not transfer any more after the effective time has lapsed. In addition, if a device existing outside of the multicast region has received data, the data is destroyed.

FIG. 6 shows a multicast communication in the case where a fixed node device does not exist in a multicast region.

As shown in FIG. 6, it is assumed that only mobile node devices exist without fixed node devices in a multicast region 600 set by a source node device S 610. A source node device S 610 does not select a group leader device, instead, selects a line passing through a multicast region 600 as a group leader line GL line 630. As shown in FIG. 6, the source node device S 610 selects the group leader line 630 to perform a multicast communication.

When a DTN routing is performed from the source node device S 610 to the group leader line 620, the DTN routing is achieved thorough a matrix using a chance to make a contact on the assumption that a line correspond to a node and a contact between lines correspond to a link. Through the above described DTN routing, a data is transferred from the source node device S 610 to the group leader line 620. The source node device S 610 selects a node device b 630, which received a data at the earliest, among node devices existing in the group leader line 620 as a group leader device GL 630. The node device b sends the source node device S 610 an acknowledgement message. The group leader device GL 630 sends group member devices passing in the multicast region 600 data while on the move.

For example, since it is already known that a node device c will enter the multicast region 600 through statistics or a route map when the node device b encounters the node device c, so the node device b forwards data to the node device c. In the case where the node device b encounters a node device d, since the node device d moves within the multicast region 600, the node device b forwards data to the node device d except when the node device d has the same data as the data the node device transfers. In this manner, the group member devices passing through the multicast region 600 receive data. The group member devices having received data may send acknowledgement messages to the node device b corresponding to the group leader device GL 630.

Meanwhile, the messages may be lost or experience significant delay during the forwarding in the DTN with its own characteristics of the DTN, so that a source node device S 710 makes a plurality of replicas and keeps sending data. In this case, a plurality of candidates for a group leader device existing in the group leader line 620 may receive data and compete with one another to become the group leader device 630. In order to prevent the candidates from competing, the source node device GL 630 may specify the group leader device when the source node device S 610 receives acknowledgement messages from the candidates.

According to an example, it may be assumed that the mobile node device b and the mobile node device b′, which correspond to the candidates for the group leader device on the group leader line 620, receive data from the source node device S 710 at the same time. In this case, each of the mobile node devices b and b′ sends an acknowledgement message to the source node device S 610. If the source node device S 610 receives the acknowledgement message of the mobile node device b earlier than that of the mobile node device b′, the source node device S 610 selects the mobile node device b as the group leader device GL 630. The acknowledgement message of the mobile node device b′, which has arrived later, is rejected.

The source node device S 610 notifies the mobile node device b′ that the node device b is the group leader device GL 630. The node device b′ keeps data forwarding while specifying on the data that the node device b′ is the group leader device. Group member devices having received from the node device b′ send acknowledgement messages to the node device b corresponding to the group leader device. In this manner, a plurality of node devices are prevented from becoming the group leader device GL 630.

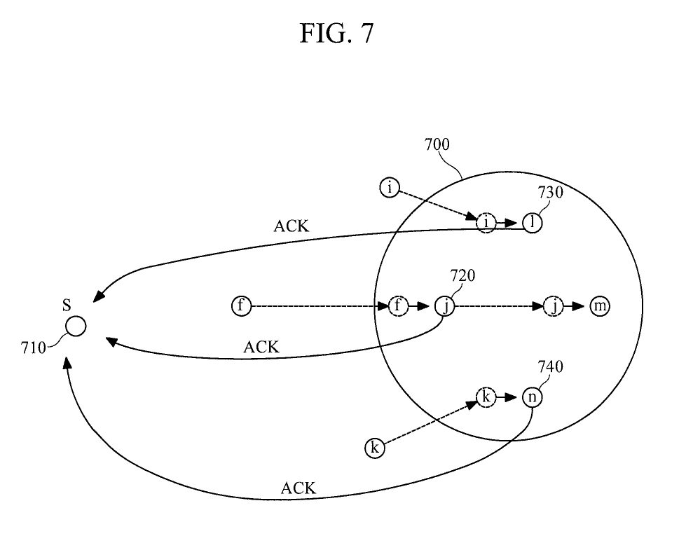

FIG. 7 shows an example of a multicast communication method in which a source node device transfers data without selecting a group leader device.

In FIG. 7, the source node device S 710 forward data without selecting a group leader device. If there is route information about a mobile device showing a regular movement, the source node device S 710 may route data to the multicast region by use of the route information. However, if there is no route information, the source node device S 710 forwards data by use of geocasting, which is dependent on the current position, random forwarding, etc. Different from using the DTN unicast routing, data is transferred through a plurality of paths between the source node device S 710 and the multicast region. Candidates for the group leader device existing in the multicast region receive data from the source node device S 710, and send acknowledgement messages to the source node device S 710. Accordingly, the source node device S 710 receives a plurality of acknowledgement messages from the candidates for the group leader device.

According to an example, the source node device S 710 having received the acknowledgement messages selects a candidate, which has sent an acknowledgement message at the earliest among other acknowledgement messages, as a group leader device 12. For example, it may be assumed that an acknowledgement message of a node device j is received at the earliest, sequentially followed by acknowledgement messages of a node device l 730 and a node device n 740. In response to the acknowledgement message of the node device j 720, the source node device S 710 selects the node device j 720 as the group leader device. In response to the acknowledgement messages of the node devices l and m 730 and 740, the source node device S 710 notifies the node devices l and m 730 and 740 that the node device j 720 is the group leader device 12. Multicast forwarding is performed also by the node devices l and m 730 and 740 as well as the node device j 720, but any node device having received multicast data sends an acknowledgement message to the node device j 720 corresponding to the group leader device.

According to another example, even through the source node device does not select the group leader device, a middle position node device may know which is a group leader node device. In this case, the middle node device forwards data while specifying on the data that the group leader device is the next destination. If necessary, the middle node device may notify the source node device that its next destination has been specified on data. In the case where the source node device does not specify the group leader device, the data routing may be erroneous and the data may be forwarded to unintended places. If an end nod device knows which is the group leader node device, the end node device sets the group leader device as its next destination for data forwarding.

FIG. 8 shows an example of a multicast communication method using a bus line map. As shown in FIG. 8, a bus route map is formed using a bus route and a bus station. In this example, the DTN node device may be regarded as the bus station and the bus. It may be assumed that the destination for multicast is a bus station existing in Gwang-san gu, and a source node device S 810 is disposed outside of Gwang-san gu.

The source node device S 810 selects a bus station, which is disposed the nearest to the source node device S 810, a group leader device GL 820. Thereafter, the source node device S 810 sets the group leader device GL 820 as the destination, and starts data forwarding to the group leader device GL 820. The data forwarding is achieved through a unicast routing scheme.

If data arrives in the group leader device GL 820, the group leader device GL 820 sends an acknowledgement message (OOB ACK) to the source node device S 810 via an Out of Band (OOB). The source node device s 810 having received the acknowledgement message OOB ACK stops data forwarding. The group leader device GL 820 transfers the data to the range of Gwang-san gu. The destination of data forwarding is the area of Gwang-san gu, and the data forwarding is achieved through a multicast routing scheme.

Thereafter, group member devices existing in Gwang-san gu that have received the data sends acknowledgment messages (ACK) to the group leader device GL 820 via inband and OOB. If the group leader device GL 820 receives acknowledgement messages from all of the group member devices in Gwan-san gu, the group leader device GL 820 stops forwarding data.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A multicast communication method by a source node device which supports a multicast in a network lacking a continuous connectivity between node devices, the multicast communication method comprising:
selecting a group leader device which is able to forward data to group member devices belonging to a multicast group; and
forwarding the data to the selected group leader device.

2. The multicast communication method of claim 1, wherein in the selecting of the group leader device, the source node device selects the group leader device in consideration of at least one of locality, the number of links and the number of nodes in a multicast region that is specified by the source node device.

3. The multicast communication method of claim 1, wherein the selecting of the group leader device comprises:
selecting a multicast path passing through the multicast region as a group leader path; and
selecting a node device, which moves along the selected group leader path, as the group leader device.

4. The multicast communication method of claim 1, wherein the selecting of the group leader device comprises:
if the group leader device is selected according to a criteria for multicast reception, receiving a result of the selecting from a server or a distributed network; and
finally selecting the group leader device according to the received result of the selecting.

5. The multicast communication method of claim 1, wherein in the forwarding of the data to the selected group leader device,
the data is forwarded to the selected group leader device through a path that is determined in a unicast routing scheme.

6. The multicast communication method of claim 1, wherein in the forwarding of the data to the selected group leader device,
the data is forwarded to the selected group leader device via mobile node devices moving along a fixed path.

7. The multicast communication method of claim 1, further comprises:
receiving an acknowledgement message from the group leader device having received the data; and
stopping forwarding data to the group leader device if the received acknowledgement message is normal.

8. The multicast communication method of claim 7, wherein in the receiving of the acknowledgement message from the group leader device having received the data,
the acknowledgement message is received from the group leader device through at least one of the network lacking a continuous connectivity and an additional communication network other than the network lacking a continuous connectivity.

9. The multicast communication method of claim 1, further comprising:
specifying a criteria for multicast for node devices, which exist in a multicast region and correspond to a final destination of multicast, in a data to be forwarded, the criteria including regional details, a type of node devices and effective time for multicast.

10. A multicast communication method by a source node device which supports a multicast in a network lacking a continuous connectivity between node devices, the multicast communication method comprising:
forwarding data to the node devices and receiving acknowledgement messages from the node devices in response to the forwarded data; and
selecting a group leader device based on the received acknowledge messages among the node devices having transferred the acknowledgement message, the group leader device capable of forwarding data to group member devices belonging to a multicast group.

11. The multicast communication method of claim 10, wherein in the selecting of the group leader device among the node devices having transferred the acknowledgement messages, a node device having transferred an acknowledgement message, which is received first among the acknowledgement messages, is selected as the group leader device when the source node device receives the acknowledgement messages.

12. The multicast communication method of claim 10, further comprising:
additionally forwarding data to the selected group leader device.

13. A multicast communication method by a group leader device which supports a multicast in a network lacking a continuous connectivity between node devices, the multicast communication method comprising:
at a source node device, selecting the group leader device; and
forwarding a data from the source node device to group member devices belonging to a multicast group after the selecting of the group leader device by the source node device.

14. The multicast communication method of claim 13, wherein the forwarding of the data to the group member devices belonging to the multicast group comprises:
setting a forwarding region by expanding a multicast region that is specified by the source node device; and
forwarding data to the group member devices belonging to the multicast group within the forwarding region.

15. The multicast communication method of claim 13, further comprising:
receiving acknowledgement messages from the group member devices belonging to the multicast group.

16. The multicast communication method of claim 13, further comprising:
if a node device newly joins the multicast group within an effective time for multicast that is specified by the source node device, forwarding a data to the newly jointed node device.

17. The method of claim 13, further comprising:
stopping forwarding data to the group member devices if a criteria for multicast forwarding success, which is set by the source node device or the group leader device, is satisfied.

18. A source node device which supports a multicast in a network lacking a continuous connectivity between node devices, the source node device comprising:
a group leader selecting unit configured to select a group leader device capable of forwarding a data to group member devices belonging to a multicast group; and
a communication unit configured to forward the data to the selected group leader device.

19. The source node device of claim 18, wherein the communication unit receives an acknowledgement message from the group leader device having received the data, and stops forwarding data to the group leader device upon reception of the acknowledgement message.

20. A multicast communication system in a network environment lacking a continuous connectivity between node devices, the multicast communication system comprising:
a source node device configured to select a group leader device and forward a data to the selected group leader device; and
the group leader device configured to forward the data, which has been transferred from the source node device, to group member devices belonging to a multicast group.
